(19) United States
(12) Patent Application Publication
(10) Pub. No.: US 2017/0109908 A1
(43) Pub. Date: Apr. 20, 2017

(54) Using Chlorophyll Data for a Marine Environment

(71) Applicant: Navico Holding AS, Egersund (NO)

(72) Inventor: Mark Griffith, Auckland (NZ)

(21) Appl. No.: 14/918,309

(22) Filed: Oct. 20, 2015

(51) Int. Cl. G06T 11/20; G01V 8/10; G06F 3/16; G09G 5/12; G06T 11/00; G06F 3/14

(52) U.S. Cl. CPC G06T 11/206; G06T 11/001; G06F 3/14; G06F 3/16; G09G 5/12; G01V 8/10; G09G 2370/02

(57) ABSTRACT

Various implementations are directed to using chlorophyll data for a marine environment. In one implementation, a non-transitory computer-readable medium may have stored thereon computer-executable instructions which, when executed by a computer, cause the computer to receive chlorophyll data from one or more chlorophyll sensors disposed on a vessel in real-time or substantially near real-time, where the chlorophyll data corresponds to a marine environment proximate to the vessel. The computer-executable instructions may also cause the computer to analyze the received chlorophyll data to determine one or more real-time or substantially near real-time chlorophyll concentrations of the marine environment. The computer-executable instructions may further cause the computer to generate a display based on the real-time or substantially near real-time chlorophyll concentrations.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

As is known in the art, the presence of chlorophyll in a marine environment may indicate the presence of phytoplankton and/or other biological matter, which can be used as food by various fish species. In particular, the chlorophyll concentrations within the marine environment may be directly proportional to the amount of phytoplankton and/or other plant matter within that environment. Thus, an operator of a vessel may use knowledge of these chlorophyll concentrations to identify potential grounds for fishing operations.

### SUMMARY

Described herein are implementations of various technologies relating to using chlorophyll data for a marine environment. In one implementation, a non-transitory computer-readable medium may have stored thereon computer-executable instructions which, when executed by a computer, cause the computer to receive chlorophyll data from one or more chlorophyll sensors disposed on a vessel in real-time or substantially near real-time, where the chlorophyll data corresponds to a marine environment proximate to the vessel. The computer-executable instructions may also cause the computer to analyze the received chlorophyll data to determine one or more real-time or substantially near real-time chlorophyll concentrations of the marine environment. The computer-executable instructions may further cause the computer to generate a display based on the real-time or substantially near real-time chlorophyll concentrations.

In another implementation, a system may include one or more chlorophyll sensors configured to be disposed on a vessel, where one or more sensors are configured to acquire chlorophyll data corresponding to a marine environment proximate to the vessel. The system may also include a marine electronics device, where the marine electronics device includes a process and a memory. The memory may include a plurality of program instructions which, when executed by the processor, cause the processor to receive the chlorophyll data from the one or more chlorophyll sensors in real-time or substantially near real-time. The plurality of program instructions which, when executed by the processor, may also cause the processor to analyze the received chlorophyll data to determine one or more real-time or substantially near real-time chlorophyll concentrations of the marine environment. The plurality of program instructions which, when executed by the processor, may further cause the processor to generate a display based on the real-time or substantially near real-time chlorophyll concentrations.

In yet another implementation, a non-transitory computer-readable medium may have stored thereon computer-executable instructions which, when executed by a computer, cause the computer to receive chlorophyll data from one or more chlorophyll sensors disposed on a vessel in real-time or substantially near real-time, where the chlorophyll data corresponds to a marine environment proximate to the vessel. The computer-executable instructions may also cause the computer to analyze the received chlorophyll data to determine one or more real-time or substantially near real-time chlorophyll concentrations of the marine environment. The computer-executable instructions may further cause the computer to generate one or more alerts based on the real-time or substantially near real-time chlorophyll concentrations.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a vessel having a chlorophyll sensor disposed thereon in accordance with implementations of various techniques described herein.

FIG. 2 illustrates a flow diagram of a method for generating a display of one or more real-time or substantially near real-time chlorophyll concentrations for a marine environment proximate to a vessel in accordance with implementations of various techniques described herein.

FIG. 3 illustrates a chart map of a marine environment proximate to a vessel in accordance with implementations of various techniques described herein.

FIG. 4 illustrates a schematic diagram of a marine electronics device having a computing system in accordance with implementations of various techniques described herein.

FIG. 5 illustrates an example schematic of a marine electronics device in accordance with implementations of various techniques described herein.

### DETAILED DESCRIPTION

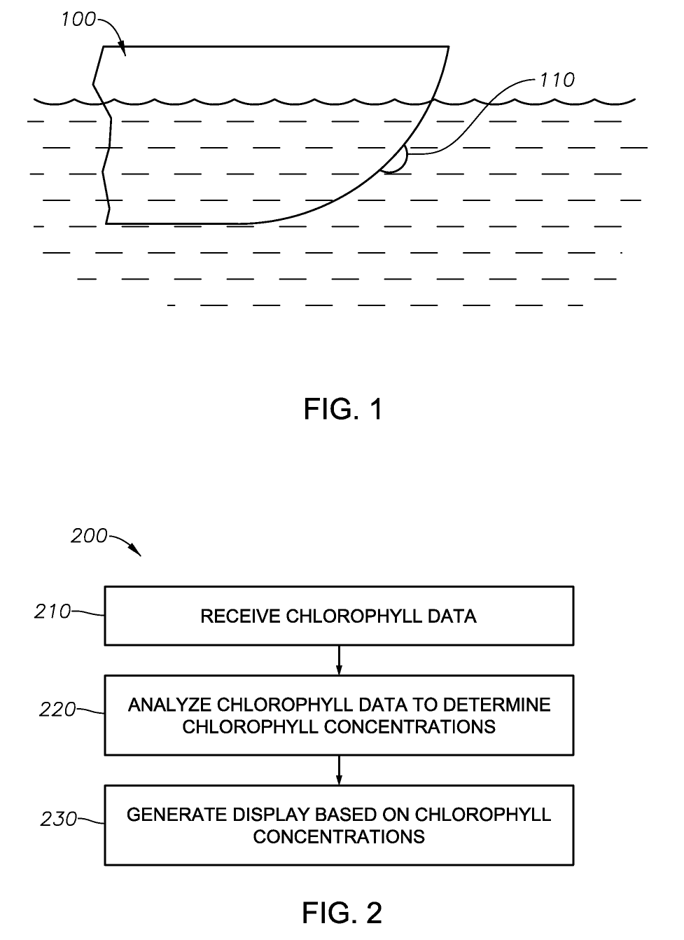

Various implementations directed to using chlorophyll data for a marine environment will now be described in the following paragraphs with reference to FIGS. 1-5.

### Chlorophyll Data

As noted above, chlorophyll in a marine environment may indicate the presence of phytoplankton and/or other biological matter, which can be used as food by various fish species. In particular, a chlorophyll concentration within the marine environment may be directly proportional to the amount of phytoplankton and/or other plant matter within that environment. As such, an operator of a vessel may use chlorophyll data for a marine environment to identify potential grounds for the fishing operations, where the chlorophyll data represents the one or more chlorophyll concentrations in the marine environment.

In some scenarios, however, the chlorophyll data used by the operator may have been acquired at an earlier point in time. Such chlorophyll data could be inaccurate due to conditions in the marine environment that have changed since the time the chlorophyll data was acquired. For example, since the time that the chlorophyll data was acquired, a water current in the marine environment may have redistributed the chlorophyll to different areas.

In one scenario, and as known to those skilled in the art, the chlorophyll data for a marine environment may be derived from satellite data. In particular, the chlorophyll data may be derived from satellite images which display the color of the water in the marine environment. Generally, the greener the water in an area, the more phytoplankton that are present in the water and, accordingly, the higher the chlorophyll concentration. These satellite images, however, may be updated only after several hours have passed. For example, some satellite images may not be updated for at least 12-24 hours. Further, satellites may be unable to obtain these images under cloudy weather conditions or due to a glare from the sunlight in some circumstances. As such, under these conditions, the satellite images may be updated even less frequently than the norm. Moreover, when using these satellite images to identify fishing grounds, an operator of a vessel may need to verify the accuracy of the chlorophyll data in the satellite images by visually inspecting the color of the water. This may be difficult, however, at night due to a lack of sunlight or at daytime due to rough water conditions. As such, chlorophyll data derived from satellite images may not be sufficiently accurate or useful for a vessel operator trying to identify potential fishing grounds.

In another scenario, and as known to those skilled in the art, the chlorophyll data for a marine environment may be derived by collecting a water sample from the environment, and then analyzing it in a laboratory at a later time to determine the chlorophyll data. However, such a procedure may be time-consuming and could take many hours to complete. Thus, chlorophyll data derived in such a way may be inaccurate by the time it is provided to an operator of a vessel searching for fishing grounds.

In contrast, in the implementations described below, chlorophyll data may be received and analyzed in order to determine one or more real-time or substantially near real-time chlorophyll concentrations of a marine environment.

In one implementation, a vessel configured to traverse a marine environment may use one or more chlorophyll sensors disposed on and/or proximate to the vessel. The vessel may be a surface water vehicle, a submersible water vehicle, or any other implementation known to those skilled in the art. The chlorophyll sensors, in particular, may be used to acquire chlorophyll data corresponding to an area of the marine environment proximate to the vessel, including areas to the side of, behind, below, and/or to the front of the vessel. As noted above, the chlorophyll data may represent the one or more real-time or substantially near real-time chlorophyll concentrations corresponding to this area. In another implementation, as the vessel traverses the marine environment, chlorophyll data may be continuously acquired. Thus, in such an implementation, the chlorophyll data may represent real-time or substantially near real-time chlorophyll concentrations for multiples areas in the environment.

The one or more chlorophyll sensors may include any chlorophyll sensor known to those skilled in the art. For example, the chlorophyll sensors may include a fluorometer, which may measure chlorophyll concentrations in water based on the optical properties of chlorophyll. As known in the art, chlorophyll may fluoresce, in that, when irradiated with light of a specific wavelength, it emits light of a higher wavelength. Fluorometers may be used to provoke the chlorophyll to fluoresce by shining a light beam onto the water, and then may determine the chlorophyll concentration in the water by measuring the subsequently emitted wavelength light. In other examples, the chlorophyll sensors may include echo sounders and sensors, chemical sensors, and/or any other chlorophyll sensor known to those skilled in the art.

The one or more chlorophyll sensors may be positioned at one or more locations on and/or proximate to the vessel, such that the chlorophyll sensors may be at least partly submerged in the water proximate to the vessel. In particular, in some implementations, the one or more chlorophyll sensors may be flexibly mounted to a hull of the vessel, to the transom of the vessel, and/or to the motor of the vessel. For example, FIG. 1 illustrates a vessel 100 having a chlorophyll sensor 110 disposed thereon in accordance with implementations of various techniques described herein. In particular, the chlorophyll sensor 110 may be coupled to a hull of the vessel 100, such that the chlorophyll sensor 110 may be configured to acquire chlorophyll data from an area of water near the vessel 100. Further, in another implementation, the one or more chlorophyll sensors may be configured to obtain chlorophyll data that has a measurement range between 0.01 milligrams per cubic meter (mg/m³) to 2 mg/m³, with a resolution of 0.01 mg/m³. The one or more chlorophyll sensors may also be configured to be smaller than the chlorophyll sensors used for laboratory analysis (as described above). The use of such smaller chlorophyll sensors may allow for easier placement of the sensors on and/or proximate to the vessel.

Once acquired, the chlorophyll data may then be sent from the one or more chlorophyll sensors to one or more marine electronics devices for processing, such that the real-time or substantially near real-time chlorophyll concentrations in the marine environment may be determined, as further described below. The one or more marine electronics devices may include a multi-function display (MFD) device, a tablet device, a smart phone, and/or any other implementation used for processing chlorophyll data known to those skilled in the art. The one or more marine electronics devices may be positioned at one or more locations on and/or proximate to the vessel. Further implementations of the marine electronics devices are discussed in greater detail in a later section. In one implementation, as also discussed below, the one or more marine electronics devices may be used to display the chlorophyll concentrations in real-time or substantially near real-time for the operator of the vessel.

FIG. 2 illustrates a flow diagram of a method 200 for generating a display of one or more real-time or substantially near real-time chlorophyll concentrations for a marine environment proximate to a vessel in accordance with implementations of various techniques described herein. In one implementation, method 200 may be performed by a marine electronics device, such as an MFD device, a tablet device, a smart phone, and/or the like. As noted above, the marine electronics device may be positioned on and/or proximate to the vessel. It should be understood that while method 200 indicates a particular order of execution of operations, in some implementations, certain portions of the operations might be executed in a different order. Further, in some implementations, additional operations or steps may be added to the method 200. Likewise, some operations or steps may be omitted. In some implementations, method 200 may be performed by multiple marine electronics devices.

At block 210, the marine electronics device may receive chlorophyll data from one or more chlorophyll sensors disposed on and/or proximate to the vessel in real-time or substantially near real-time. The chlorophyll sensors may be similar to those described above. As noted above, the chlorophyll data may represent real-time or substantially near real-time chlorophyll concentrations for one or more areas in the marine environment. In one implementation, the one or more chlorophyll sensors may provide the chlorophyll data to the marine electronics device at predetermined intervals, such as, for example, every one to two seconds.

The marine electronics device may receive the chlorophyll data from the one or more chlorophyll sensors in an analog and/or digital format. Further, the marine electronics device may receive the chlorophyll data from the one or more chlorophyll sensors via wired and/or wireless communication using any technology known to those skilled in the art.

At block 220, the marine electronics device may analyze the chlorophyll data received from the one or more chlorophyll sensors. Using the chlorophyll data, the marine electronics device may determine the one or more real-time or substantially near real-time chlorophyll concentrations for the marine environment.

As noted above, the one or more chlorophyll sensors may provide the chlorophyll data to the marine electronics device at predetermined intervals, such as, for example, every one to two seconds. Accordingly, in one implementation, the marine electronics device may analyze the chlorophyll data in a continuous fashion in order to determine the real-time or substantially near real-time chlorophyll concentrations for the marine environment.

In another implementation, as the vessel traverses the marine environment, the marine electronics device may keep track of the locations in the marine environment from where the received chlorophyll data were acquired by the one or more chlorophyll sensors. In such an implementation, the marine electronics device may determine these locations via global positioning system (GPS) technology or any other navigational technology known to those skilled in the art.

At block 230, the marine electronics device may generate a display based on the one or more real-time or substantially near real-time chlorophyll concentrations for the marine environment (as determined at block 220). The marine electronics device may use a display element (as further described below) to show the generated display to an operator of the vessel.

In one implementation, the generated display of the real-time or substantially near real-time chlorophyll concentrations may include visual representations of the chlorophyll concentrations, which may be shown in combination with a chart map of the marine environment. The chart map may be a real-time or substantially near real-time representation of the marine environment proximate to the vessel, and may include a symbol or a marker that is representative of the geographical location of the vessel. As noted above, the chart map may be obtained using known chart maps and/or may be derived using GPS technology, sonar data, or any other navigational technology known to those skilled in the art.

The visual representations of the chlorophyll concentrations may be illustrated on the chart map, and may represent locations where the chlorophyll data corresponding to those chlorophyll concentrations were acquired by the chlorophyll sensors. In one implementation, the chlorophyll concentrations (as determined at block 220) may be separated into different ranges, where the visual representation for each range may be represented on the chart map as a unique color. For example, a higher range of chlorophyll concentrations may be represented by a green color, whereas a lower range of chlorophyll concentrations may be represented by a blue color. These colors may be overlaid onto the chart map to indicate where the areas with different ranges of chlorophyll concentrations are located in the marine environment.

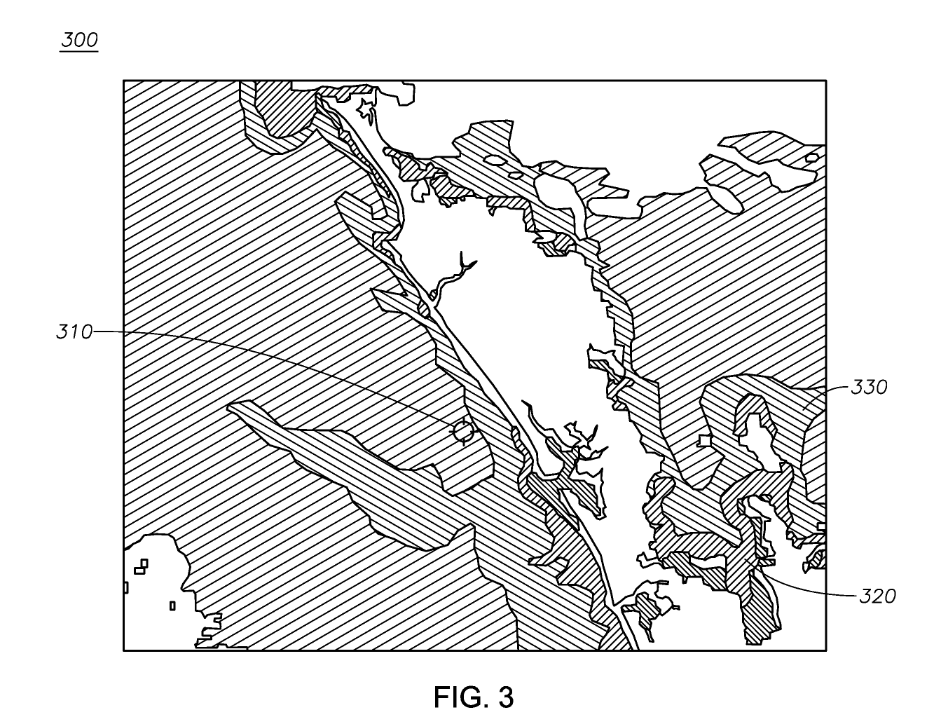

For example, FIG. 3 illustrates a chart map 300 of a marine environment proximate to a vessel in accordance with implementations of various techniques described herein. The chart map 300 includes a symbol 310 indicating a real-time or substantially near real-time location of the vessel. The chart map 300 also shows areas in the marine environment proximate to the vessel having different ranges of real-time or substantially near real-time chlorophyll concentrations (as determined at block 220). In particular, an area 320 may have a higher chlorophyll concentration than an area 330. Such a chart map 330 may be generated by a marine electronics device, where each area in the map 300 corresponds to a different range of chlorophyll concentration and may be represented by a unique color.

In another implementation, the generated display may be in the form of an alert for the operator of the vessel. The alert may indicate if the real-time or substantially near real-time chlorophyll concentrations in an area proximate to the vessel (as determined at block 220) have changed by a predetermined amount and/or a predetermined percentage in a predetermined amount of time or for a predetermined range of distance. For example, the marine electronics device may provide such an alert if the real-time chlorophyll concentration has changed significantly in the one nautical mile area proximate to the vessel. In another example, the marine electronics device may provide such an alert if the real-time chlorophyll concentration has changed significantly for an area proximate the vessel over a sixty minute time span. In yet another implementation, the alert may be provided based on a comparison with chlorophyll concentration amounts derived from satellite data (as described above). In other implementations, the generated display may include any visual representation of chlorophyll concentrations that would be known to those skilled in the art. In yet another implementation, the marine electronics device may provide an audio alert instead of, or in addition to, the displayed alert. The marine electronics device may also provide an alert, as described above, based on measurements for water temperature in the area proximate to the vessel.

In yet another implementation, the generated display may be transferred to a server computing system, a cloud computing system, and/or the like. In such an implementation, the generated display of the one or more real-time or substantially near real-time chlorophyll concentrations for the marine environment may be shared for use by other vessel operators.

In sum, implementations relating to using chlorophyll data for a marine environment, described above with respect to FIGS. 1-3, may help an operator of a vessel to determine the one or more chlorophyll concentrations in the marine environment, which may allow the operator to identify potential fishing grounds. Furthermore, the implementations described above may provide the operator with more up-to-date (i.e., real-time or substantially near real-time) and accurate chlorophyll data when compared to chlorophyll data derived from satellite data and/or from laboratory analysis.

Marine Electronics Device

As noted above, once acquired, the chlorophyll data may be sent from the one or more chlorophyll sensors to one or more marine electronics devices for processing, such that the real-time or substantially near real-time chlorophyll concentrations in the marine environment may be determined. The one or more marine electronics devices may include a multi-function display (MFD) device, a tablet device, a smart phone, and/or any other implementation used for processing chlorophyll data known to those skilled in the art. The one or more marine electronics devices may be positioned at one or more locations on and/or proximate to the vessel.

The marine electronics device may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

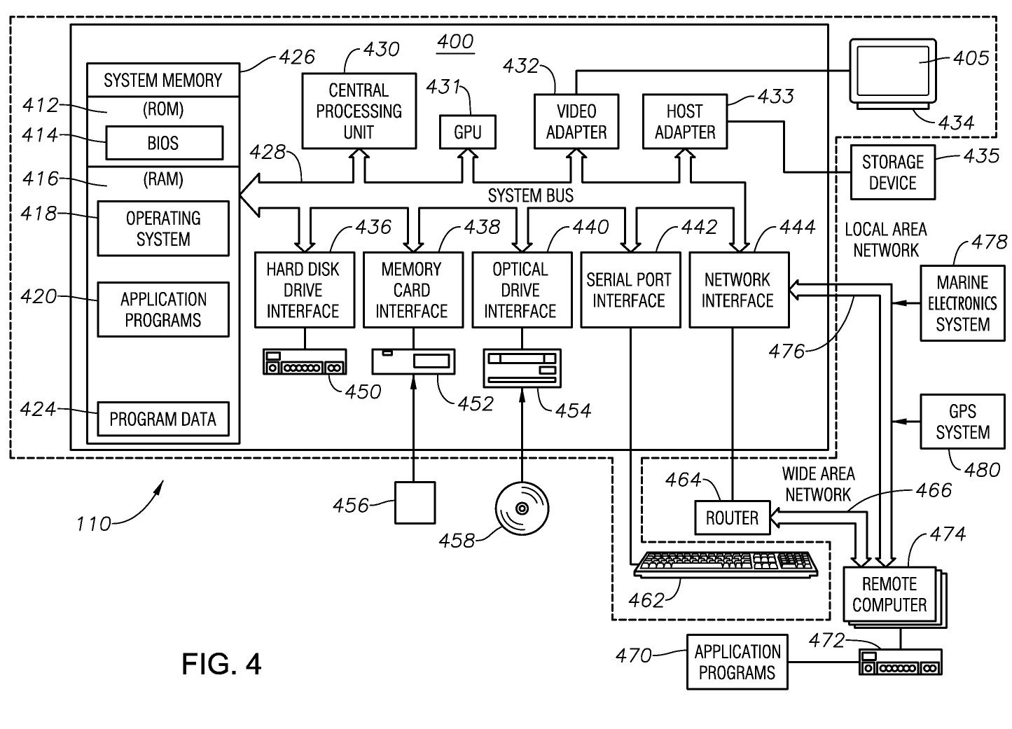

FIG. 4 illustrates a schematic diagram of a marine electronics device having a computing system 400 in accordance with implementations of various techniques described herein. The marine electronics device may be any type of electrical and/or electronics device capable of processing data via the computing system 400. In one implementation, the marine electronics device may be a marine instrument, such that the marine electronics device may use the computing system 400 to display and/or process the one or more types of marine electronics data.

The computing system 400 may include a central processing unit (CPU) 430, a system memory 426, a graphics processing unit (GPU) 431 and a system bus 428 that couples various system components including the system memory 426 to the CPU 430. Although only one CPU 430 is illustrated in FIG. 4, it should be understood that in some implementations the computing system 400 may include more than one CPU 430.

The CPU 430 may include a microprocessor, a microcontroller, a processor, a programmable integrated circuit, or a combination thereof. The CPU 430 can comprise an off-the-shelf processor such as a Reduced Instruction Set Computer (RISC), or a Microprocessor without Interlocked Pipeline Stages (MIPS) processor, or a combination thereof. The CPU 430 may also include a proprietary processor.

The GPU 431 may be a microprocessor specifically designed to manipulate and implement computer graphics. The CPU 430 may offload work to the GPU 431. The GPU 431 may have its own graphics memory, and/or may have access to a portion of the system memory 426. As with the CPU 430, the GPU 431 may include one or more processing units, and each processing unit may include one or more cores.

The CPU 430 may provide output data to a GPU 431. The GPU 431 may generate graphical user interfaces that present the output data. The GPU 431 may also provide objects, such as menus, in the graphical user interface. A user may provide inputs by interacting with the objects. The GPU 431 may receive the inputs from interaction with the objects and provide the inputs to the CPU 430. A video adapter 432 may be provided to convert graphical data into signals for a monitor 434. The monitor 434 includes a display element (i.e., screen) 405. In certain implementations, the display element 405 may be sensitive to touching by a finger. In other implementations, the display element 405 may be sensitive to the body heat from the finger, a stylus, or responsive to a mouse. The display element 405 may be used to show the generated display discussed above with respect to block 230 of FIG. 2.

The system bus 428 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 426 may include a read only memory (ROM) 412 and a random access memory (RAM) 416. A basic input/output system (BIOS) 414, containing the basic routines that help transfer information between elements within the computing system 400, such as during start-up, may be stored in the ROM 412.

The computing system 400 may further include a hard disk drive interface 436 for reading from and writing to a hard disk 450, a memory card reader 452 for reading from and writing to a removable memory card 456, and an optical disk drive 454 for reading from and writing to a removable optical disk 458, such as a CD ROM or other optical media. The hard disk 450, the memory card reader 452, and the optical disk drive 454 may be connected to the system bus 428 by a hard disk drive interface 436, a memory card reader interface 438, and an optical drive interface 440, respectively. The drives and their associated computer-readable media may provide nonvolatile storage of computer-readable instructions, data structures, program modules and other data for the computing system 400.

Although the computing system 400 is described herein as having a hard disk, a removable memory card 456 and a removable optical disk 458, it should be appreciated by those skilled in the art that the computing system 400 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 400. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 400 may also include a host adapter 433 that connects to a storage device 435 via a small computer system interface (SCSI) bus, a Fiber Channel bus, an eSATA bus, or using any other applicable computer bus interface.

The computing system 400 can also be connected to a router 464 to establish a wide area network (WAN) 466 with one or more remote computers 474. The router 464 may be connected to the system bus 428 via a network interface 444. The remote computers 474 can also include hard disks 472 that store application programs 470.

In another implementation, the computing system 400 may also connect to the remote computers 474 via local area network (LAN) 476 or the WAN 466. When using a LAN networking environment, the computing system 400 may be connected to the LAN 476 through the network interface or adapter 444. The LAN 476 may be implemented via a wired connection or a wireless connection. The LAN 476 may be implemented using Wi-Fi™ technology, cellular technology, Bluetooth™ technology, satellite technology, or any other implementation known to those skilled in the art. The network interface 444 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 474. It will be appreciated that the network connections shown are exemplary and other means of establishing a communications link between the computer systems may be used.

A number of program modules may be stored on the hard disk 450, memory card 456, optical disk 458, ROM 412 or RAM 416, including an operating system 418, one or more application programs 420, and program data 424. In certain implementations, the hard disk 450 may store a database system. The database system could include, for example, recorded points. The application programs 420 may include various mobile applications (“apps”) and other applications configured to perform various methods and techniques described herein. The operating system 418 may be any suitable operating system that may control the operation of a networked personal or server computer.

A user may enter commands and information into the computing system 400 through input devices such as buttons 462, which may be physical buttons, virtual buttons, or combinations thereof. Other input devices may include a microphone, a mouse, or the like (not shown). These and other input devices may be connected to the CPU 430 through a serial port interface 442 coupled to system bus 428, but may be connected by other interfaces, such as a parallel port, game port or a universal serial bus (USB).

Certain implementations may be configured to be connected to a global positioning system (GPS) receiver system 480 and/or a marine electronics system 478. The GPS system 480 and/or marine electronics system 478 may be connected via the network interface 444.

The GPS receiver system 480 may be used to determine position data for the vessel on which the marine electronics device is disposed. The GPS receiver system 480 may then transmit the position data to the marine electronics device. In other implementations, any positioning system known to those skilled in the art may be used to determine and/or provide the position data for the marine electronics device.

The marine electronics system 478 may include one or more components disposed at various locations on and/or proximate to the vessel. Such components may include one or more data modules, sensors, instrumentation, and/or any other devices known to those skilled in the art that may transmit various types of data to the marine electronics device for processing and/or display. The various types of data transmitted to the marine electronics device from the marine electronics system 478 may include marine electronics data and/or other data types known to those skilled in the art. The marine electronics data received from the marine electronics system 478 may include chart data, chlorophyll data, sonar data, structure data, radar data, navigation data, position data, heading data, automatic identification system (AIS) data, speed data, course data, and/or any other type known to those skilled in the art. In some implementations, the radar data may include Doppler data.

In one implementation, the marine electronics system 478 may include a radar sensor for recording the radar data, a compass heading sensor for recording the heading data, and a position sensor for recording the position data. In a further implementation, the marine electronics system 478 may include a sonar transducer for recording the sonar data, an AIS transponder for recording the AIS data, a paddlewheel sensor for recording the speed data, and/or the like.

The marine electronics device may receive external data via the LAN 476 or the WAN 466. In one implementation, the external data may relate to information not available from the marine electronics system 478. The external data may be retrieved from the Internet or any other source. The external data may include atmospheric temperature, tidal data, weather, moon phase, sunrise, sunset, water levels, historic fishing data, and other fishing data.

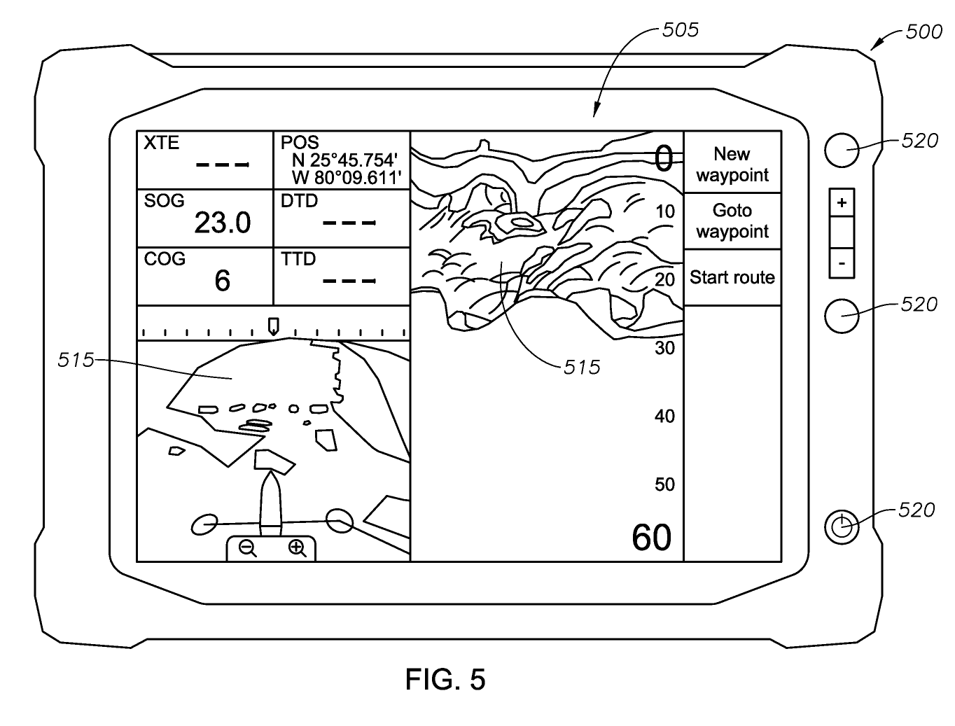

FIG. 5 illustrates an example schematic of a marine electronics device 500 in accordance with implementations of various techniques described herein. The marine electronics device 500 may be in the form of an MFD device.

The MFD device 500 includes a screen 505, which may be similar to the display element 405 discussed above. In certain implementations, the screen 505 may be sensitive to touching by a finger. In other implementations, the screen 505 may be sensitive to the body heat from the finger, a stylus, or responsive to a mouse. The marine electronics device 500 may be attached to a NMEA bus or network. The MFD device 500 may send or receive data to or from another device attached via the NMEA 2000 bus, Ethernet (LAN), and/or the like. For example, the MFD device 500 may transmits commands and receive data from a motor or a sensor using an NMEA 2000bus. In one implementation, the MFD device 500 may be capable of steering a vessel and controlling the speed of the vessel, i.e., autopilot. For example, one or more waypoints may be input to the marine electronics device 500, and the MFD device 500 may steer a vessel to the one or more waypoints. The MFD device 500 may transmit or receive NMEA 2000 compliant messages, messages in a proprietary format that do not interfere with NMEA 2000 compliant messages or devices, or messages in any other format. The device 500 may display marine electronic data 515. The marine electronic data types 515 may include chart data, chlorophyll data, radar data, sonar data, steering data, dashboard data, navigation data, fishing data, engine data, and the like. The MFD device 500 may also include a plurality of buttons 520, which may be either physical buttons or virtual buttons, or a combination thereof. The MFD device 500 may receive input through a screen 505 sensitive to touch or buttons 520.

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. The computing systems may be configured to operate using various radio frequency technologies and implementations, such as sonar, radar, GPS, and like technologies.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

The discussion of the present disclosure is directed to certain specific implementations. It should be understood that the discussion of the present disclosure is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of the implementations and combinations of elements of different implementations within the scope of the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort maybe complex and time consuming, but would nevertheless be a routine undertaking of design, fabrication, and manufacture for those of ordinary skill having benefit of this disclosure. Nothing in this application should be considered critical or essential to the claimed subject matter unless explicitly indicated as being “critical” or “essential.”

Reference has been made in detail to various implementations, examples of which are illustrated in the accompanying drawings and figures. In the following detailed description, numerous specific details are set forth to provide a thorough understanding of the present disclosure. However, the present disclosure may be practiced without these specific details. In other instances, well-known methods, procedures, components, circuits and networks have not been described in detail so as not to unnecessarily obscure aspects of the embodiments.

It should also be understood that, although the terms first, second, etc., may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations and is not intended to limit the present disclosure. As used in the description of the present disclosure and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon computer-executable instructions which, when executed by a computer, cause the computer to:
receive chlorophyll data from one or more chlorophyll sensors disposed on a vessel in real-time or substantially near real-time, wherein the chlorophyll data corresponds to a marine environment proximate to the vessel;
analyze the received chlorophyll data to determine one or more real-time or substantially near real-time chlorophyll concentrations of the marine environment; and
generate a display based on the real-time or substantially near real-time chlorophyll concentrations.

2. The non-transitory computer-readable medium of claim 1, wherein the generated display comprises one or more visual representations of the one or more real-time or substantially near real-time chlorophyll concentrations combined with a chart map of the marine environment.

3. The non-transitory computer-readable medium of claim 2, wherein the chart map comprises a real-time or substantially near real-time representation of the marine environment, and wherein the chart map includes a symbol representing a real-time or substantially near real-time location of the vessel in the marine environment.

4. The non-transitory computer-readable medium of claim 2, wherein each visual representation corresponds to a different range of the one or more real-time or substantially near real-time chlorophyll concentrations, and wherein each visual representation is shown as a different color on the chart map.

5. The non-transitory computer-readable medium of claim 1, wherein the program instructions which, when executed by the computer, cause the computer to generate the display, further comprise program instructions which, when executed by the computer, cause the computer to generate one or more alerts indicating whether the one or more real-time or substantially near real-time chlorophyll concentrations have changed by a predetermined amount or a predetermined percentage in a predetermined amount of time.

6. The non-transitory computer-readable medium of claim 1, wherein the one or more chlorophyll sensors are mounted to a hull of the vessel, to a transom of the vessel, or to a motor of the vessel.

7. The non-transitory computer-readable medium of claim 1, wherein the one or more chlorophyll sensors include a fluorometer.

8. The non-transitory computer-readable medium of claim 1, wherein the program instructions which, when executed by the computer, cause the computer to receive the chlorophyll data, further comprise program instructions which, when executed by the computer, cause the computer to receive the chlorophyll data at predetermined intervals.

9. The non-transitory computer-readable medium of claim 1, wherein the program instructions which, when executed by the computer, cause the computer to analyze the received chlorophyll data, further comprise program instructions which, when executed by the computer, cause the computer to analyze the received chlorophyll data continuously as the vessel traverses the marine environment.

10. The non-transitory computer-readable medium of claim 1, wherein the computer-executable instructions which, when executed by a computer, further cause the computer to transmit the generated display to a server computing system, a cloud computing system, or combinations thereof.

11. The non-transitory computer-readable medium of claim 1, wherein the computer-executable instructions which, when executed by a computer, further cause the computer to display the generated display using a multi-function display (MFD) device.

12. A system comprising:
one or more chlorophyll sensors configured to be disposed on a vessel, wherein one or more sensors are configured to acquire chlorophyll data corresponding to a marine environment proximate to the vessel;
a marine electronics device, comprising:
a processor;
a memory comprising a plurality of program instructions which, when executed by the processor, cause the processor to:
receive the chlorophyll data from the one or more chlorophyll sensors in real-time or substantially near real-time;
analyze the received chlorophyll data to determine one or more real-time or substantially near real-time chlorophyll concentrations of the marine environment; and
generate a display based on the real-time or substantially near real-time chlorophyll concentrations.

13. The system of claim 12, wherein the generated display comprises one or more visual representations of the one or more real-time or substantially near real-time chlorophyll concentrations combined with a chart map of the marine environment.

14. The system of claim 13, wherein the chart map comprises a real-time or substantially near real-time representation of the marine environment, and wherein the chart map includes a symbol representing a real-time or substantially near real-time location of the vessel in the marine environment.

15. The system of claim 13, wherein each visual representation corresponds to a different range of the one or more real-time or substantially near real-time chlorophyll concentrations, and wherein each visual representation is shown as a different color on the chart map.

16. The system of claim 12, wherein the generated display comprises one or more alerts indicating whether the one or more real-time or substantially near real-time chlorophyll concentrations have changed by a predetermined amount or a predetermined percentage for a predetermined range of distance.

17. A non-transitory computer-readable medium having stored thereon computer-executable instructions which, when executed by a computer, cause the computer to:
receive chlorophyll data from one or more chlorophyll sensors disposed on a vessel in real-time or substantially near real-time, wherein the chlorophyll data corresponds to a marine environment proximate to the vessel;
analyze the received chlorophyll data to determine one or more real-time or substantially near real-time chlorophyll concentrations of the marine environment; and
generate one or more alerts based on the real-time or substantially near real-time chlorophyll concentrations.

18. The non-transitory computer-readable medium of claim 17, wherein the program instructions which, when executed by the computer, cause the computer to generate the one or more alerts, further comprise program instructions which, when executed by the computer, cause the computer generate the one or more alerts based on whether the one or more real-time or substantially near real-time chlorophyll concentrations have changed by a predetermined amount or a predetermined percentage in comparison to a predetermined value.

19. The non-transitory computer-readable medium of claim 17, wherein the one or more alerts are configured to be displayed using a display element.

20. The non-transitory computer-readable medium of claim 17, wherein the one or more alerts comprise one or more audio alerts.
